(19) United States
(12) Patent Application Publication
(10) Pub. No.: US 2025/0017262 A1
(43) Pub. Date: Jan. 16, 2025

(54) AEROSOL-GENERATING ARTICLE WITH NOVEL AEROSOL-GENERATING SUBSTRATE

(71) Applicant: Philip Morris Products S.A., Neuchatel (CH)

(72) Inventor: Guillaume Bastien BAUR, Lausanne (CH)

(73) Assignee: Philip Morris Products S.A., Neuchatel (CH)

(21) Appl. No.: 18/713,802

(22) PCT Filed: Dec. 5, 2022
(86) PCT No.: PCT/EP2022/084388

§ 371 Date: May 28, 2024

(30) Foreign Application Priority Data
Dec. 6, 2021 (EP) 21212564.5

(51) Int. Cl. A24D 1/20; A24B 15/167; A24F 40/465

(52) U.S. Cl. CPC A24D 1/20; A24B 15/167; A24F 40/465

(57) ABSTRACT

An aerosol-generating article including an aerosol-generating substrate is provided, the aerosol-generating substrate including a porous medium loaded with an aerosol-generating suspension of plant particles in a liquid solvent including one or more aerosol formers, the aerosol-generating suspension including at least 20 percent by weight of the plant particles and at least 30 percent by weight of the one or more aerosol formers. A method of producing an aerosol-generating substrate for the aerosol-generating article is also provided.

The present invention relates to an aerosol-generating substrate for an aerosol-generating article, to an aerosol-generating article comprising such an aerosol-generating substrate, and to a method for the production of such an aerosol-generating substrate.

Aerosol-generating articles in which an aerosol-generating substrate, such as a nicotine-containing substrate or a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article.

Substrates for heated aerosol-generating articles have, in the past, often been produced using randomly oriented shreds, strands, or strips of tobacco material. As an alternative, rods for heated aerosol-generating articles formed from gathered sheets of tobacco material have been disclosed, by way of example, in international patent application WO-A-2012/164009.

International patent application WO-A-2011/101164 discloses alternative rods for heated aerosol-generating articles formed from strands of homogenised tobacco material, which may be formed by casting, rolling, calendering or extruding a mixture comprising particulate tobacco and at least one aerosol former to form a sheet of homogenised tobacco material. In alternative embodiments, the rods of WO-A-2011/101164 may be formed from strands of homogenised tobacco material obtained by extruding a mixture comprising particulate tobacco and at least one aerosol former to form continuous lengths of homogenised tobacco material.

It is also known to provide aerosol-generating articles comprising homogenised plant materials formed with non-tobacco plants, such as botanical materials, for providing non-tobacco flavours to the consumer. The non-tobacco material may be provided in addition to tobacco material, or as an alternative to tobacco material. However, with certain non-tobacco plant materials it has been found to be technically difficult to form a homogenised plant material using conventional casting processes that has sufficient structural integrity to be formed into a rod for an aerosol-generating article. This potentially restricts the selection of plant materials that can be incorporated into a homogenised plant material

Homogenised tobacco material is typically heated at relatively high temperatures during use, for example around 350 degrees Celsius, in order to optimise the generation of aerosol and the release of nicotine from the tobacco. For this reason, aerosol-generating articles comprising homogenised tobacco material are commonly heated in aerosol-generating devices comprising an internal heating element, which is inserted into a rod of the homogenised tobacco, in order to heat it internally.

Alternative forms of substrates comprising nicotine have also been disclosed. By way of example, liquid nicotine compositions, often referred to as e-liquids, have been proposed. These liquid compositions may, for example, be heated by a coiled electrically resistive filament of an aerosol-generating device. Substrates of this type may require particular care in the manufacture of the containers holding the liquid composition in order to prevent undesirable leakages. To address this issue and simplify the overall manufacturing process, it has also been proposed to provide a gel composition comprising nicotine that generates a nicotine-containing aerosol upon heating. By way of example, WO-A-2018/019543 discloses a thermoreversible gel composition, that is, a gel that will become fluid when heated to a melting temperature and will set into a gel again at a gelation temperature. The gel is provided within a housing of a cartridge, and the cartridge can be disposed of and replaced when the gel has been consumed.

Such gel compositions may not be suitable for use in directly forming a rod of aerosol-generating substrate for an aerosol-generating article, as it is difficult to retain the gel within the rod of aerosol-generating substrate and so there are problems with leakage of the gel out of the article.

It would be desirable to provide a novel aerosol-generating substrate for an aerosol-generating article that can provide a more effective release of aerosol and nicotine at a lower temperature, such as the temperatures that are provided by aerosol-generating devices that incorporate external heating means or induction heating means. It would be particularly desirable if such an aerosol-generating substrate could be provided that reduces or preferably substantially eliminates any issues with leakage that are experienced with liquid and gel substrates. It would be further desirable to provide such an aerosol-generating substrate that can be readily and efficiently manufactured and incorporated into existing aerosol-generating articles without significant modification to the article construction and methods of assembly.

The present invention relates to an aerosol-generating substrate for an aerosol-generating article, the aerosol-generating substrate comprising a porous medium loaded with a heterogeneous aerosol-generating suspension. The aerosol-generating suspension may comprise plant particles in a liquid solvent comprising one or more aerosol formers. The aerosol-generating suspension may comprise at least 20 percent by weight of the plant particles. The aerosol-generating suspension may comprise at least 30 percent by weight of the one or more aerosol formers.

According to a first aspect of the present invention there is provided an aerosol-generating substrate for an aerosol-generating article, the aerosol-generating substrate comprising: a porous medium loaded with a heterogeneous aerosol-generating suspension of plant particles in a liquid solvent comprising one or more aerosol formers, the aerosol-generating suspension comprising at least 20 percent by weight of the plant particles and at least 30 percent by weight of the one or more aerosol formers.

According to a second aspect of the present invention there is provided an aerosol-generating article comprising a rod formed of an aerosol generating substrate, the aerosol-generating substrate comprising: a porous medium loaded with an heterogeneous aerosol-generating suspension of plant particles in a liquid solvent comprising one or more aerosol formers, the aerosol-generating suspension comprising at least 20 percent by weight of the plant particles and at least 30 percent by weight of the one or more aerosol formers.

According to a third aspect of the present invention there is provided a method of producing an aerosol-generating substrate, the method comprising the steps of: providing a liquid solvent comprising one or more aerosol formers and optionally water; providing a plant powder formed of plant particles; mixing the plant powder with the liquid solvent to form a heterogeneous suspension of the plant particles in the liquid solvent; and depositing the heterogeneous suspension onto a porous medium to form the aerosol-generating suspension.

According to the invention there is provided an aerosol-generating article comprising an aerosol-generating substrate, the aerosol-generating substrate comprising: a porous medium loaded with an aerosol-generating suspension of plant particles in a liquid solvent comprising one or more aerosol formers, the aerosol-generating suspension comprising at least 20 percent by weight of the plant particles and at least 30 percent by weight of the one or more aerosol formers.

Any references herein to features of the aerosol-generating article or aerosol-generating substrate according to the present invention should be assumed to apply to all aspects of the present invention, unless stated otherwise.

As used herein, the term “aerosol-generating article” refers to a heated aerosol-generating article for producing an aerosol comprising an aerosol-generating substrate that is intended to be heated rather than combusted in order to release volatile compounds that can form an aerosol. Such articles are commonly referred to as heat-not-burn articles.

As used herein, the term “aerosol-generating substrate” refers to a substrate capable of releasing upon heating volatile compounds, which can form an aerosol. The aerosol generated from aerosol-generating substrates of aerosol-generating articles described herein may be visible or invisible and may include vapours (for example, fine particles of substances, which are in a gaseous state, that are ordinarily liquid or solid at room temperature) as well as gases and liquid droplets of condensed vapours.

As used herein, the term “aerosol-generating suspension” refers to a suspension that is capable of releasing upon heating volatile compounds, which can form an aerosol. The aerosol-generating suspension of the present invention is a heterogeneous mixture of plant particles suspended in a liquid solvent. The plant particles are not dissolved in the liquid solvent but are distributed through it. In the context of the present invention, the aerosol-generating suspension is defined as non-colloidal. In particular, the aerosol-generating suspension is not a gel and does not include a gelling agent. As used herein, the term “gelling agent” refers to thickening agents that increase the viscosity of the aerosol-generating suspension through the formation of a colloidal gel. Common gelling agents include gums, pectin, agar and gelatin.

As used herein, the term “porous medium” refers to any suitable porous carrier material that provides a structure having a plurality of pores and is capable of retaining the aerosol-generating suspension within its pores. The porous medium must be capable of being incorporated into a rod of aerosol-generating substrate for an aerosol-generating article. The porous medium is inert, and in particular, sensorially inert so that it does not contribute to the aerosol formed upon heating of the aerosol-generating substrate.

As used herein, the term “loaded” is used to describe the retention of the aerosol-generating suspension within the porous medium. In other words, the porous medium is “filled” with the aerosol-generating suspension and is effectively holding it, or carrying it, within the aerosol-generating substrate. The porous medium therefore acts as a porous carrier to contain and retain the aerosol-generating suspension within the aerosol-generating substrate. As described above, the aerosol-generating suspension is dispersed within the porous structure of the porous medium and can be effectively retained within its pores.

As described above, the present invention provides a novel aerosol-generating substrate having a heterogeneous aerosol-generating suspension loaded onto a porous medium. The aerosol-generating suspension provides plant material in the form of plant particles, which are suspended in a liquid solvent comprising one or more aerosol formers. This provides a novel way of combining the plant material and aerosol former within an aerosol-generating substrate.

The use of an aerosol-generating suspension as defined has been found to optimise the generation of aerosol and the release of nicotine and other active substances when the aerosol-generating substrate is heated at a relatively low temperature, for example at a temperature of below around 275 degrees Celsius. This advantageously enables the aerosol-generating substrates to be used in aerosol-generating articles which are intended to be heated in aerosol-generating devices with external heating means, which heat a rod of aerosol-generating substrate externally and which typically heat the aerosol-generating substrate to a temperature of between about 230 and 270 degrees Celsius. The aerosol-generating substrates may also be suitable for heating by induction means, where the substrate will also typically be heated to a relatively low temperature.

It has surprisingly been found what when the plant particles and aerosol former are provided in the form of a suspension, as defined, a lower temperature is needed in order to aerosolise the volatile compounds from the aerosol-generating substrate compared to aerosol-generating substrates in sheet form, such as cast leaf. The use of lower temperatures is particularly advantageous because the levels of certain undesirable aerosol compounds are typically reduced. Overall, the ratio of desirable compounds to undesirable compounds in the aerosol can therefore be maximised. This optimises the overall experience provided to the consumer upon use.

The aerosol-generating suspension of the present invention can advantageously be formed with any plant material and therefore provides a highly versatile form of substrate. In particular, the aerosol-generating suspension can be advantageously used for botanical materials that cannot be effectively formed into homogenised plant materials, as described above.

The form of the aerosol-generating substrate, with the aerosol-generating suspension supported on the porous medium is found to effectively retain the aerosol-generating suspension in place within the aerosol-generating substrate. Leakage of the aerosol-generating suspension from the aerosol-generating substrate is therefore minimised or substantially prevented. Migration of the aerosol-generating suspension within the aerosol-generating article is also substantially prevented. The use of an aerosol-generating substrate in the form of a suspension therefore provides significant benefits over the use of liquid or gel substrates.

The aerosol-generating substrate of the present invention can be produced with a relatively straightforward production method that does not require complex processing steps, such as gelation. The aerosol-generating suspension is typically relatively viscous so that it can be readily deposited on the porous medium, as described below. The relatively high viscosity of the aerosol-generating suspension additionally improves the retention of the aerosol-generating suspension in the porous medium, as discussed above.

The combination of the porous medium with the aerosol-generating suspension supported on it can be readily formed into the form of a rod of aerosol-generating substrate, which can be combined with other components to form an aerosol-generating article having a similar construction to existing aerosol-generating articles. This means that the aerosol-generating substrate of the present invention can advantageously be incorporated into aerosol-generating articles without the need to significantly modify the processes or apparatus for assembling the aerosol-generating articles.

As defined above, the aerosol-generating substrate of the present invention is in the form of an aerosol-generating suspension dispersed within a porous medium. The aerosol-generating suspension is a suspension of plant particles in a liquid solvent, wherein the liquid solvent comprises one or more aerosol formers and optionally one or more of water, alkaline and nicotine, as discussed in more detail below.

As used herein, the term “plant particles” encompasses particles derived from any suitable plant material and which are capable of generating one or more volatile flavour compounds upon heating. This term should be considered to exclude particles consisting of inert plant material such as inert cellulose powder, that do not contribute to the sensory output of the aerosol-generating substrate. Depending upon the plant from which the plant particles are derived, the plant particles may be produced from ground or powdered leaf lamina, fruits, stalks, stems, roots, seeds, buds or bark or any other suitable portion of the plant.

As used herein, the term “inert” refers to materials that are sensorially inert, in that they have a negligible or zero contribution to the flavour or smell of the aerosol generated from the aerosol-generating suspension.

According to the invention, the aerosol-generating suspension includes at least about 20 percent by weight of the plant particles, more preferably at least about 25 percent by weight of the plant particles and more preferably at least about 30 percent by weight of the plant particles, based on the total weight of the aerosol-generating suspension (including any water).

Preferably, the aerosol-generating suspension comprises up to about 50 percent by weight of the plant particles, more preferably up to about 45 percent by weight of the plant particles, based on the total weight of the aerosol-generating suspension.

For example, the aerosol-generating suspension may comprise between about 20 percent and about 50 percent by weight of the plant particles, or between about 25 percent by weight and about 50 percent by weight of the plant particles, or between about 30 percent by weight and about 50 percent by weight of the plant particles, or between about 20 percent by weight and about 45 percent by weight of the plant particles, or between about 25 percent by weight and about 45 percent by weight of the plant particles, or between about 30 percent by weight and about 45 percent by weight of the plant particles, based on the total weight of the aerosol-generating suspension.

The provision of plant particles within this weight range ensures that the aerosol-generating suspension is sufficiently viscous that it can be successfully applied to and retained on the porous medium. In addition, it enables sufficient plant material to be provided within the aerosol-generating substrate so that an aerosol having desirable levels of active compounds and flavour compounds can be provided.

The aerosol-generating substrate preferably comprises at least about 8 percent by weight of the plant particles, based on total weight of the aerosol-generating substrate including the aerosol-generating suspension and the porous medium. More preferably, the aerosol-generating substrate comprises at least about 15 percent by weight of the plant particles and most preferably at least about 20 percent by weight of the plant particles.

Preferably, the aerosol-generating substrate comprises up to about 40 percent by weight of the plant particles, more preferably up to about 35 percent by weight of the plant particles and more preferably up to about 30 percent by weight of the plant particles, based on total weight of the aerosol-generating substrate including the aerosol-generating suspension and the porous medium.

For example, the aerosol-generating substrate may comprise between about 8 percent and about 40 percent by weight of the plant particles, or between about 15 percent by weight and about 35 percent by weight of the plant particles, or between about 20 percent by weight and about 30 percent by weight of the plant particles, based on the total weight of the aerosol-generating substrate.

Preferably, aerosol-generating articles according to the invention comprise at least about 25 milligrams of plant particles per rod of aerosol-generating substrate, more preferably at least about 40 milligrams of plant particles per rod of aerosol-generating substrate, more preferably at least about 60 milligrams of plant particles per rod of aerosol-generating substrate.

Preferably, aerosol-generating articles according to the invention comprise up to about 125 milligrams of plant particles per rod of aerosol-generating substrate, more preferably up to about 100 milligrams of plant particles per rod of aerosol-generating substrate, more preferably up to about 80 milligrams of plant particles per rod of aerosol-generating substrate.

The plant particles in the aerosol-generating suspension may originate from a single plant type, or may be a combination of plant particles from two or more plant types. Preferably, the aerosol-generating suspension comprises tobacco particles. Alternatively or in addition to the tobacco particles, the aerosol-generating suspension may comprise non-tobacco particles. In certain embodiments of the invention, the aerosol-generating suspension is substantially free to tobacco particles.

With reference to all embodiments of the present invention, the term “tobacco particles” describes particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of the invention and are not included in the percentage of particulate plant material.

The tobacco particles may be prepared from one or more varieties of tobacco plants. Any type of tobacco may be used in a blend. Examples of tobacco types that may be used include, but are not limited to, sun-cured tobacco, flue-cured tobacco, Burley tobacco, Maryland tobacco, Oriental tobacco, Virginia tobacco, and other specialty tobaccos. In certain embodiments of the invention, the aerosol-generating suspension comprising tobacco particles originating from the Nicotiana rustica tobacco variety, which is known to provide a relatively high nicotine content compared to other tobacco varieties.

Flue-curing is a method of curing tobacco, which is particularly used with Virginia tobaccos. During the flue-curing process, heated air is circulated through densely packed tobacco. During a first stage, the tobacco leaves turn yellow and wilt. During a second stage, the laminae of the leaves are completely dried. During a third stage, the leaf stems are completely dried.

Burley tobacco plays a significant role in many tobacco blends. Burley tobacco has a distinctive flavour and aroma and also has an ability to absorb large amounts of casing.

Oriental is a type of tobacco which has small leaves, and high aromatic qualities. However, Oriental tobacco has a milder flavour than, for example, Burley. Generally, therefore, Oriental tobacco is used in relatively small proportions in tobacco blends.

Kasturi, Madura and Jatim are subtypes of sun-cured tobacco that can be used. Preferably, Kasturi tobacco and flue-cured tobacco may be used in a blend to produce the tobacco particles. Accordingly, the tobacco particles in the particulate plant material may comprise a blend of Kasturi tobacco and flue-cured tobacco.

The tobacco particles may have a nicotine content of at least about 2.5 percent by weight, based on dry weight. More preferably, the tobacco particles may have a nicotine content of at least about 3 percent, even more preferably at least about 3.2 percent, even more preferably at least about 3.5 percent, most preferably at least about 4 percent by weight, based on dry weight. When the aerosol-generating substrate contains tobacco particles in combination with non-tobacco particles, tobaccos having a higher nicotine content are preferred to maintain similar levels of nicotine relative to typical aerosol-generating substrates without non-tobacco particles, since the total amount of nicotine would otherwise be reduced due to substitution of tobacco particles with non-tobacco particles.

The non-tobacco particles, where present, may derive from one or more non-tobacco plants, depending upon the desired flavour of the resultant aerosol. Preferably, the non-tobacco plant particles comprise mint leaf particles, rosemary particles, ginger particles, star anise particles, clove particles, eucalyptus particles, oregano particles, thyme particles, dill seed particles, chamomile particles, cumin seed particles, tea particles, cannabis particles, or combinations thereof.

In embodiments of the invention where a combination of non-tobacco and tobacco particles is provided in the aerosol-generating suspension, the weight ratio of the non-tobacco plant particles to the tobacco particles in the aerosol-generating suspension may vary depending on the desired flavour characteristics and composition of the aerosol. For example, the weight ratio of non-tobacco plant particles to tobacco particles may be between about 1:60 and 60:1, or between about 1:10 and about 10:1, or between about 1:5 and 5:1. In preferred embodiments of the present invention, the weight ratio of non-tobacco particles to tobacco particles is no more than about 1:4, more preferably no more than about 1:5 and more preferably no more than about 1:6.

For example, in a particular preferred embodiment, the ratio by weight of non-tobacco particles to tobacco particles in the aerosol-generating suspension is 1:4. A 1:4 ratio corresponds to plant particles consisting of about 20 percent by weight of the non-tobacco particles and about 80 percent by weight of the tobacco particles.

Preferably, the plant particles are provided in the form of a powdered plant material that has been purposely ground to from particles having a desired particle size distribution. Preferably, the average particle size of the plant particles is between about 20 microns and about 200 microns, more preferably between about 50 microns and about 150 microns, more preferably between about 50 microns and about 100 microns.

In certain embodiments of the invention, the aerosol-generating suspension may further comprise an inert thickening agent. The inert thickening agent may optionally be added in addition to the plant particles, if there is a need to further increase the viscosity of the aerosol-generating suspension. The inert particles of thickening agent, where present, are suspended in the liquid solvent together with the plant particles. As defined above, the inert particles will have a negligible or zero contribution to the flavour or smell of the aerosol generated from the aerosol-generating suspension. Suitable thickening agents would be known to the skilled person and include, for example, cellulose, cellulose derivatives, starch, natural gums and combinations thereof. Preferably, the thickening agent is not a gelling agent and is capable of increasing the viscosity of the aerosol-generating suspension without the formation of a gel.

As described above, the plant particles are suspended in a liquid solvent which is preferably an aqueous liquid solvent. The liquid solvent comprises one or more aerosol formers. Upon volatilization, an aerosol former can convey other vaporised compounds released from the aerosol-generating substrate upon heating, such as nicotine and flavourants, in an aerosol. The aerosolisation of a specific compound from an aerosol-generating substrate is determined not solely by its boiling point. The quantity of a compound that is aerosolised can be affected by the physical form of the substrate, as well as by the other components that are also present in the substrate. The stability of a compound under the temperature and time frame of aerosolisation will also affect the amount of the compound that is present in an aerosol.

Suitable aerosol formers for inclusion in the liquid solvent are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid solvent may comprise a single aerosol former, or a combination of two or more aerosol formers.

In preferred embodiments of the invention, the aerosol-generating suspension comprises a liquid solvent comprising glycerol, alone or in combination with propylene glycol.

As defined above, the aerosol-generating suspension of aerosol-generating substrates according to the present invention includes at least about 30 percent by weight of the one or more aerosol formers, based on the total weight of the aerosol-generating suspension (including water, where present). Preferably, the aerosol-generating suspension comprises at least about 35 percent by weight of the one or more aerosol formers, more preferably at least about 40 percent by weight of the one or more aerosol formers, more preferably at least about 45 percent by weight of the one or more aerosol formers, more preferably at least about 50 percent by weight of the one of more aerosol formers.

Preferably, the aerosol-generating suspension comprises up to about 90 percent by weight of the one or more aerosol formers, more preferably up to about 85 percent by weight of the one or more aerosol formers, more preferably up to about 80 percent by weight of the one or more aerosol formers, more preferably up to about 75 percent by weight of the one or more aerosol former, more preferably up to about 70 percent by weight of the one or more aerosol formers.

For example, the aerosol-generating suspension may comprise between about 30 percent and about 90 percent by weight of the one or more aerosol formers, or between about 35 percent and about 85 percent by weight of the one or more aerosol formers, or between about 40 percent and about 80 percent by weight of the one or more aerosol formers, or between about 45 percent and about 75 percent by weight of the one or more aerosol formers, or between about 50 percent and about 70 percent by weight of the one or more aerosol formers.

The level of aerosol former in the aerosol-generating suspension and the ratio of the plant particles to the aerosol former can be adjusted in order to provide the desired viscosity for the aerosol-generating suspension.

The aerosol-generating substrate preferably comprises at least about 25 percent by weight of the one or more aerosol formers, based on total weight of the aerosol-generating substrate including the aerosol-generating suspension and the porous medium. More preferably, the aerosol-generating substrate comprises at least about 30 percent by weight of the one or more aerosol formers and most preferably at least about 40 percent by weight of the one or more aerosol formers.

Preferably, the aerosol-generating substrate comprises up to about 75 percent by weight of the one or more aerosol formers, more preferably up to about 70 percent by weight of the one or more aerosol formers and more preferably up to about 60 percent by weight of the one or more aerosol formers, based on total weight of the aerosol-generating substrate including the aerosol-generating suspension and the porous medium.

For example, the aerosol-generating substrate may comprise between about 25 percent and about 75 percent by weight of the one or more aerosol formers, or between about 30 percent by weight and about 70 percent by weight of the one or more aerosol formers, or between about 40 percent by weight and about 60 percent by weight of the one or more aerosol formers, based on the total weight of the aerosol-generating substrate.

Preferably, aerosol-generating articles according to the invention comprise at least about 75 milligrams of the one or more aerosol formers per rod of aerosol-generating substrate, more preferably at least about 100 milligrams of the one or more aerosol formers per rod of aerosol-generating substrate, more preferably at least about 125 milligrams of the one or more aerosol formers per rod of aerosol-generating substrate.

Preferably, aerosol-generating articles according to the invention comprise up to about 225 milligrams of the one or more aerosol formers per rod of aerosol-generating substrate, more preferably up to about 200 milligrams of the one or more aerosol formers per rod of aerosol-generating substrate, more preferably up to about 175 milligrams of the one or more aerosol formers per rod of aerosol-generating substrate.

Preferably, the liquid solvent of the aerosol-generating suspension further comprises water. The inclusion of water in the liquid solvent has been found to be advantageous since it acts as a heat transfer agent, which enhances the vaporisation of aerosol former and nicotine, where present. For example, where the aerosol-generating substrate comprises a susceptor element, as described below, the presence of water in the aerosol-generating suspension can additionally help to dissipate the heat generated from the susceptor element during use. This effect may also be helpful with other heating means. Upon heating of the water in the liquid solvent, it will vaporize and the resultant water vapour will transfer to parts of the aerosol-generating substrate that may be distant from the heat source. By condensing on these other parts of the aerosol-generating substrate, heat is released and this is believed to enhance the vaporisation of glycerol and nicotine (where present) from the aerosol-generating substrate.

The inclusion of water in the liquid solvent is particularly advantageous for aerosol-generating suspensions comprising tobacco material, or nicotine, or a combination thereof, as the presence of water has been found to provide a significant increase in the amount of nicotine delivered in the aerosol generated upon heating of the aerosol-generating substrate according to the invention, due to the improvement in heat transfer within the aerosol-generating substrate. In some cases, the inclusion of water has been found to increase the amount of nicotine delivered per puff from a tobacco containing aerosol-generating substrate according to the invention by between 50 percent and 100 percent compared to a similar substrate without the water.

Preferably, the aerosol-generating suspension comprises at least about 5 percent by weight of water, more preferably at least about 7.5 percent by weight of water and more preferably at least about 10 percent by weight of water, based on the total weight of the aerosol-generating suspension.

Preferably, the aerosol-generating suspension comprises up to about 30 percent by weight of water, more preferably up to about 25 percent by weight of water and more preferably up to about 20 percent by weight of water.

For example, the aerosol-generating suspension may comprise between about 5 percent and 30 percent by weight of water, or between about 7.5 percent and 25 percent by weight of water, or between about 10 percent by weight and 20 percent by weight of water.

Preferably, the aerosol-generating substrate according to the present invention comprises up to about 25 percent by weight of water, based on the total weight of the aerosol-generating substrate including the aerosol-generating suspension and the porous medium. More preferably, the aerosol-generating substrate comprises up to about 15 percent by weight of water, more preferably up to about 10 percent by weight of water, based on the total weight of the aerosol-generating substrate.

Aerosol-generating articles according to the present invention preferably contain up to about 75 milligrams of water per rod of aerosol-generating substrate, more preferably up to about 60 milligrams of water per rod of aerosol-generating substrate, more preferably up to about 40 milligrams of water per rod of aerosol-generating substrate.

Alternatively or in addition to the inclusion of water in the liquid solvent of the aerosol-generating suspension, the liquid solvent may further comprise an alkaline agent. The inclusion of an alkaline agent is particularly beneficial for embodiments containing tobacco material, or nicotine, or a combination thereof. It has been found that the presence of the alkaline agent in the liquid solvent provides a significant increase in the amount of nicotine delivered in the aerosol generated from the aerosol-generating substrate of the present invention. In some cases, the inclusion of an alkaline agent has been found to increase the amount of nicotine delivered per puff from a tobacco containing aerosol-generating substrate according to the invention by between 50 percent and 100 percent compared to a similar substrate without the alkaline agent.

Without wishing to be bound by theory, it is believed that the higher pH obtained upon addition of the alkaline agent in the liquid solvent leads to deprotonation of the nicotine to its free form, which is easier to release in the gas phase. Therefore, if the tobacco particles are alkalized, the release of nicotine can occur at a lower temperature.

The alkaline agent may be in the form of any suitable alkaline compound, including but not limited to hydroxides such as sodium hydroxide, potassium hydroxide, magnesium hydroxide or calcium hydroxide. In preferred embodiments, the alkaline agent is sodium hydroxide.

Preferably, the aerosol-generating suspension including the alkaline agent has a pH of at least about 6, more preferably at least about 6.5, more preferably at least about 7.

Preferably, the aerosol-generating suspension including the alkaline agent has a pH of up to about 9, more preferably up to about 8.5, more preferably up to about 8. For example, the aerosol-generating suspension may have a pH of between about 6 and about 9, or between about 6.5 and about 8.5, or between about 7 and about 8.

Preferably, the aerosol-generating suspension comprises at least about 0.1 percent by weight of the alkaline agent, more preferably at least about 0.25 percent by weight of the alkaline agent and more preferably at least about 0.5 percent by weight of the alkaline agent, based on the total weight of the aerosol-generating suspension (including water, where present).

Preferably, the aerosol-generating suspension comprises up to about 5 percent by weight of the alkaline agent, more preferably up to about 4 percent by weight of the alkaline agent and more preferably up to about 2.5 percent by weight of the alkaline agent.

For example, the aerosol-generating suspension may comprise between about 0.1 percent and 5 percent by weight of alkaline agent, or between about 0.25 percent and 4 percent by weight of alkaline agent, or between about 0.5 percent by weight and 2.5 percent by weight of alkaline agent.

Preferably, the aerosol-generating substrate according to the present invention comprises up to about 4 percent by weight of alkaline agent, based on the total weight of the aerosol-generating substrate including the aerosol-generating suspension and the porous medium. More preferably, the aerosol-generating substrate comprises up to about 2.5 percent by weight of alkaline agent, more preferably up to about 1 percent by weight of alkaline agent, based on the total weight of the aerosol-generating substrate.

Aerosol-generating articles according to the present invention preferably contain up to about 12.5 milligrams of alkaline agent per rod of aerosol-generating substrate, more preferably up to about 7.5 milligrams of alkaline agent per rod of aerosol-generating substrate, more preferably up to about 2.5 milligrams of alkaline agent per rod of aerosol-generating substrate.

Alternatively or in addition, the liquid solvent of the aerosol-generating suspension may further comprise nicotine. The nicotine is preferably in the form of liquid nicotine, which can be readily provided in combination with the one or more aerosol formers, as well as optional water.

Alternatively or in addition, the liquid solvent of the aerosol-generating substrate may further comprise one or more acids. Preferably, the liquid solvent comprise one or more organic acids. Even more preferably, the liquid solvent comprise one or more carboxylic acids.

Suitable carboxylic acids for use in the aerosol-generating substrate in accordance with the present invention include, but are not limited to: 2-Ethylbutyric acid, acetic acid, adipic acid, benzoic acid, butyric acid, cinnamic acid, cycloheptane-carboxylic acid, fumaric acid, glycolic acid, hexanoic acid, lactic acid, levulinic acid, malic acid, myristic acid, octanoic acid, oxalic acid, propanoic acid, pyruvic acid, succinic acid, and undecanoic acid.

In particularly preferred embodiments, the acid is lactic acid, levulinic acid, benzoic acid, levulinic acid, fumaric acid or acetic acid. Most preferably, the acid is lactic acid.

The inclusion of an acid is advantageously found to stabilise dissolved species in the aerosol-generating suspension, in particular, nicotine. Without wishing to be bound by theory, it is understood that the acid may interact with the nicotine molecule, such that protonated nicotine is stabilised. As protonated nicotine is non-volatile, it is more easily found in the liquid or particulate phase rather than in the vapour phase of an aerosol obtained by heating the aerosol-generating element. As such, the loss of nicotine during manufacturing of the aerosol-generating element can be minimised, and higher, better controlled nicotine delivery to the consumer can advantageously be ensured.

The resultant suspension of plant particles in the liquid solvent preferably has a relatively high viscosity, so that the aerosol-generating suspension is paste-like in texture. Preferably, the aerosol-generating suspension is in the form of a paste. This facilitates the application of the aerosol-generating suspension onto the porous medium and also optimises retention of the aerosol-generating suspension within the aerosol-generating substrate during storage and use. The provision of a relatively high viscosity also advantageously prevents the settling of the plant particles in the liquid solvent. As defined above, the viscosity will be largely defined by the weight ratio of the liquid solvent including the aerosol formers to the solid particles (including plant particles and any optional thickening agent), with a higher proportion of solid particles providing a more viscous suspension. The aerosol-generating suspension is preferably substantially free from gelling agent and so there is no gelation of the suspension which may affect the viscosity.

Preferably, the weight ratio of the liquid solvent to the plant particles in the aerosol-generating suspension is at least about 1, more preferably at least about 1.5, more preferably at least about 2.

Preferably, the weight ratio of the liquid solvent to the plant particles in the aerosol-generating suspension is up to about 4, more preferably up to about 4.5, more preferably up to about 5. For example, the weight ratio of liquid solvent to the plant particles may be between about 1 and about 5, or between about 1.5 and about 4.5, or between about 2 and about 4.

Preferably, the weight ratio of the plant particles to the liquid solvent in the aerosol-generating suspension is at least about 0.2, more preferably at least about 0.25, more preferably at least about 0.3.

Preferably, the weight ratio of the plant particles to the liquid solvent in the aerosol generating suspension is up to about 1, more preferably up to about 0.8, more preferably up to about 0.75. For example, the weight ratio of the plant particles to the liquid solvent may be between about 0.2 and about 1, or between about 0.25 and about 0.8, or between about 0.3 and about 0.75.

Preferably, the weight ratio of the liquid solvent to the total solids in the aerosol-generating suspension is at least about 1, more preferably at least about 1.5, more preferably at least about 1.75. The total solids includes the plant particles and any optional components in solid form, such as thickening agent.

Preferably, the weight ratio of the liquid solvent to the total solids in the aerosol-generating suspension is up to about 5, more preferably up to about 4, more preferably up to about 3. For example, the weight ratio of liquid solvent to the total solids may be between about 1 and about 5, or between about 1.5 and about 4, or between about 1.75 and about 3.

Preferably, the weight ratio of the total solids to the liquid solvent in the aerosol-generating suspension is at least about 0.2, more preferably at least about 0.25, more preferably at least about 0.3, more preferably at least about 0.4.

Preferably, the weight ratio of the total solids to the liquid solvent in the aerosol-generating suspension is up to about 1, more preferably up to about 0.8, more preferably up to about 0.75, more preferably up to about 0.6. For example, the weight ratio of the plant particles to the liquid solvent may be between about 0.2 and about 1, or between about 0.25 and about 0.8, or between about 0.3 and about 0.75, or between about 0.4 and about 0.6.

The provision of this balance of plant particles or total solids with liquid solvent ensures that the aerosol-generating suspension is sufficiently viscous, in order to provide the benefits as set out above.

As described above, in the aerosol-generating substrates of the present invention, the aerosol-generating suspension is loaded onto a porous medium. The porous medium acts as an inert carrier element for supporting and retaining the aerosol-generating suspension within the aerosol-generating substrate. The porous medium has a porous structure defining a plurality of pores. The aerosol-generating suspension is dispersed within the porous structure of the porous medium, so that it can be retained within the plurality of pores. The porous medium may take any suitable form that is suitable for this purpose and which can be formed into a cylindrical rod so that the aerosol-generating substrate may be incorporated into aerosol-generating articles as described below.

The porous medium is preferably formed of a fibrous material. For example, in preferred embodiments of the invention, the porous medium is in the form of a fibrous sheet. Preferably, the porous medium is in the form of a cellulosic sheet, formed of a fibrous cellulosic material. Suitable cellulosic materials include but are not limited to cotton, viscose, hemp, bamboo, coconut, kenaf and combinations thereof. Alternatively, the porous medium may be in the form of a non-cellulosic sheet, formed of a non-cellulosic material such as silicone or carbon fibres.

Preferably, the porous medium is in the form of one or more crimped sheets. As used herein, the term “crimped sheet” denotes a sheet having a plurality of substantially parallel ridges or corrugations usually aligned with the longitudinal axis of the substrate or article. Particularly preferably, the porous medium comprises one or more crimped cotton sheets.

The one or more sheets forming the porous medium may optionally be gathered to form a plug. As used herein, the term “gathered” denotes that the sheet forming the porous medium is convoluted, folded, or otherwise compressed or constricted substantially transversely to the cylindrical axis of a plug or a rod. The step of “gathering” the sheet may be carried out by any suitable means which provides the necessary transverse compression of the sheet.

Other forms of the porous medium may alternatively be used in the aerosol-generating substrate of the present invention. For example, the porous medium may take the form of a porous plug of a fibrous material, or a hollow tubular element of a fibrous material.

The porous medium preferably accounts for between about 10 percent and about 30 percent by weight of the aerosol-generating substrate, or between about 15 and about 25 percent by weight of the aerosol-generating substrate, based on the total weight of the aerosol-generating substrate including the porous medium and the aerosol-generating suspension.

Aerosol-generating articles according to the present invention preferably include between about 40 milligrams and about 80 milligrams of the porous medium per rod of aerosol-generating substrate, more preferably between about 50 milligrams and about 70 milligrams of the porous medium per rod of aerosol-generating substrate.

The mass and volume of the porous medium should be selected to provide sufficient retention of the aerosol-generating suspension that is to be incorporated in the aerosol-generating substrate. The amount of the aerosol-generating suspension that can be retained by the porous medium will depend to a certain extent on the nature of the porous medium and in particular, the porosity of the porous medium.

It is typically desirable to maximise the weight ratio of the aerosol-generating suspension to the porous medium in order to optimise the levels of aerosol that can be generated from the aerosol-generating substrate. Preferably, the weight ratio of the aerosol-generating suspension to the porous medium within the aerosol-generating substrate is at least about 3, more preferably at least about 4. Preferably, the weight ratio of the aerosol-generating suspension to the porous medium within the aerosol-generating substrate is no more than about 8. The ratio should be adapted such that the aerosol-generating suspension can be retained within the porous medium without significant leakage of the aerosol-generating suspension prior to use.

The aerosol-generating suspension may be applied to the porous medium using any suitable means. As described above, the aerosol-generating suspension will typically have a relatively high viscosity and will be in the form of a thick paste, which can be spread onto one or more surfaces of the porous medium. The aerosol-generating suspension may become impregnated into the porous medium at least to a certain extent.

Once the porous medium has been loaded with the aerosol-generating suspension, the combination is preferably formed into a rod shape and circumscribed by one or more wrappers along at least a part of its length. The one or more wrappers may include a paper wrapper or a non-paper wrapper, or both. Suitable paper wrappers for use in specific embodiments of the invention are known in the art and include, but are not limited to: cigarette papers; and filter plug wraps.

In certain embodiments, the resultant aerosol-generating substrate includes one or more susceptor elements. For example, one or more susceptor element may be included in aerosol-generating substrates that are intended to be heated by induction, as described below.

The one or more susceptor elements may be a plurality of susceptor particles which may be deposited on or embedded within the aerosol-generating substrate. When the porous medium of the aerosol-generating substrate is in the form of one or more sheets, a plurality of susceptor particles may be deposited on or embedded within the one or more sheets. The susceptor particles are immobilized by the substrate, for example, in sheet form, and remain at an initial position. Preferably, the susceptor particles may be homogeneously distributed in the porous medium of the aerosol-generating substrate. Due to the particulate nature of the susceptor, heat is produced according to the distribution of the particles in the porous medium. Alternatively, the susceptor in the form of one or more sheets, strips, shreds or rods may also be placed next to the porous medium or used as embedded in the porous medium. In one embodiment, the aerosol forming substrate comprises one or more susceptor strips. For example, the rod of aerosol-generating substrate may comprise an elongate susceptor element extending longitudinally through it. In another embodiment, the susceptor is present in the aerosol-generating device.

The susceptor may have a heat loss of more than 0.05 Joule per kilogram, preferably a heat loss of more than 0.1 Joule per kilogram. Heat loss is the capacity of the susceptor to transfer heat to the surrounding material. Because the susceptor particles are preferably homogeneously distributed in the aerosol-generating substrate, a uniform heat loss from the susceptor particles may be achieved thus generating a uniform heat distribution in the aerosol-generating substrate and leading to a uniform temperature distribution in the aerosol-generating article. It has been found that a specific minimal heat loss of 0.05 Joule per kilogram in the susceptor particles allows for heating of the aerosol-generating substrate to a substantially uniform temperature, thus providing aerosol generation. Preferably, the average temperatures achieved within the aerosol-generating substrate in such embodiments are about 200 degree Celsius to about 280 degrees Celsius.

Reducing the risk of overheating the aerosol-generating substrate may be supported by the use of susceptor materials having a Curie temperature, which allows a heating process due to hysteresis loss only up to a certain maximum temperature. The susceptor may have a Curie temperature between about 200 degree Celsius and about 450 degree Celsius, preferably between about 240 degree Celsius and about 400 degree Celsius, for example about 280 degree Celsius. When a susceptor material reaches its Curie temperature, the magnetic properties change. At the Curie temperature the susceptor material changes from a ferromagnetic phase to a paramagnetic phase. At this point, heating based on energy loss due to orientation of ferromagnetic domains stops. Further heating is then mainly based on eddy current formation such that a heating process is automatically reduced upon reaching the Curie temperature of the susceptor material. Preferably, susceptor material and its Curie temperature are adapted to the composition of the aerosol-generating substrate in order to achieve an optimal temperature and temperature distribution in the aerosol-generating substrate for an optimum aerosol generation.

In some preferred embodiments of the invention, the susceptor is made of ferrite. Ferrite is a ferromagnet with a high magnetic permeability and especially suitable as susceptor material. The main component of ferrite is iron. Other metallic components, for example, zinc, nickel, manganese, or non-metallic components, for example silicon, may be present in varying amounts. Ferrite is a relatively inexpensive, commercially available material. Ferrite is available in particle form in the size ranges of the particles used in the particulate plant material forming the homogenised rosemary material according to the invention. Preferably, the particles are a fully sintered ferrite powder, such as for example FP160, FP215, FP350 by PPT, Indiana USA.

Preferably, the aerosol-generating substrate has a length of between about 5 millimetres and about 20 millimetres, more preferably between about 8 millimetres and about 15 millimetres, more preferably between about 10 millimetres and about 12 millimetres.

Preferably, the aerosol-generating substrate has an external diameter of between about 5 millimetres and about 12 millimetres, more preferably between about 5 millimetres and about 10 millimetres, more preferably between about 6 millimetres and about 8 millimetres. Typically, the aerosol-generating substrate has an external diameter of approximately 7.2 millimetres.

As defined above, the present invention further provides a method for the production of the aerosol-generating substrate according to the invention, as described in detail above.

In a first step of the method according to the invention, the liquid solvent is prepared. As described above, the liquid solvent comprises one or more aerosol formers which are preferably combined with water to form an aqueous solution. The one or more aerosol formers and the water are preferably mixed to form a homogenous solution. Where an alkaline agent is included in the liquid solvent, this is preferably combined with the water prior to the addition of the one or more aerosol formers.

In a second step, a plant powder formed of plant particles is provided. A powder is formed from the selected plant material using grinding or milling to obtain the desired particle size of the plant particles. Where two or more different plant materials are used for the aerosol-generating suspension, these plant materials may be combined prior to grinding, or after.

In a third step, the plant particles are added to the liquid solvent and mixed to form an aerosol-generating suspension, which has a paste like consistency. The aerosol-generating suspension is mixed until the plant particles are substantially evenly distributed through the liquid solvent.

In a fourth step, the aerosol-generating suspension is deposited onto a porous medium to form the aerosol-generating substrate. For example, the aerosol-generating suspension may be extruded onto the porous medium.

The porous medium, with the aerosol-generating suspension loaded onto it, may then be formed into a rod and the rod may be circumscribed with an outer wrapper, using suitable means.

Preferably, the aerosol-generating suspension is substantially free from gelling agent. As defined above in relation to the aerosol-generating substrate, the aerosol-generating suspension formed in the method of the present invention is defined as non-colloidal.

Preferably, the method according to the invention does not include a gelling step.

In some embodiments, the method according to the invention may not include a drying step.

The aerosol-generating articles according to the invention comprise a rod of the aerosol-generating substrate as described in detail above, circumscribed by an outer wrapper. The rod of aerosol-generating substrate is preferably combined with one or more additional components.

Aerosol-generating articles according to the invention may optionally include a support element comprising at least one hollow tube immediately downstream of the aerosol-generating substrate. One function of the tube is to locate the aerosol-generating substrate towards the distal end of the aerosol-generating article so that it can be contacted with a heating element. The tube acts to prevent the aerosol-generating substrate from being forced along the aerosol-generating article towards other downstream elements when a heating element is inserted into the aerosol-generating substrate. The tube also acts as a spacer element to separate the downstream elements from the aerosol-generating substrate. The tube can be made of any material, such as cellulose acetate, a polymer, cardboard, or paper.

Alternatively or in addition, aerosol-generating articles according to the invention optionally comprise an aerosol-cooling element downstream of the aerosol-generating substrate and immediately downstream of the hollow tube forming the support element. In use, an aerosol formed by volatile compounds released from the aerosol-generating substrate passes through and is cooled by the aerosol-cooling element before being inhaled by a user. The lower temperature allows the vapours to condense into an aerosol. The aerosol-cooling element may be a hollow tube, such as a hollow cellulose acetate tube or a cardboard tube, which can be similar to the support element that is immediately downstream of the aerosol-generating substrate. The aerosol-cooling element may be a hollow tube of equal outer diameter but smaller or larger inner diameter than the hollow tube forming the support element. In one embodiment, the aerosol-cooling element wrapped in paper comprises one or more longitudinal channels made of any suitable material, such as a metallic foil, a paper laminated with a foil, a polymeric sheet preferably made of a synthetic polymer, and a substantially non-porous paper or cardboard. In some embodiments, the aerosol-cooling element wrapped in paper may comprise one or more sheets made of a material selected from the group consisting of polyethylene (PE), polypropylene (PP), polyvinylchloride (PVC), polyethylene terephthalate (PET), polylactic acid (PLA), cellulose acetate (CA), paper laminated with a polymeric sheet and aluminium foil. Alternatively, the aerosol-cooling element may be made of woven or non-woven filaments of a material selected from the group consisting of polyethylene (PE), polypropylene (PP), polyvinylchloride (PVC), polyethylene terephthalate (PET), polylactic acid (PLA), and cellulose acetate (CA). In a preferred embodiment, the aerosol-cooling element is a crimped and gathered sheet of polylactic acid wrapped within a filter paper. In another preferred embodiment, the aerosol-cooling element comprises a longitudinal channel and is made of woven filaments of a synthetic polymer, such as polylactic acid filaments, which are wrapped in paper.

One or more additional hollow tubes may be provided downstream of the aerosol-cooling element.

Aerosol-generating articles according to the invention may further comprise a filter or mouthpiece downstream of the aerosol-generating substrate and, where present, the support element and aerosol-cooling element. The filter or mouthpiece may comprise one or more filter elements. The filter may comprise one or more filtration materials for the removal of particulate components, gaseous components, or a combination thereof. Suitable filtration materials are known in the art and include, but are not limited to: fibrous filtration materials such as, for example, cellulose acetate tow and paper; adsorbents such as, for example, activated alumina, zeolites, molecular sieves and silica gel; biodegradable polymers including, for example, polylactic acid (PLA), Mater-Bi®, hydrophobic viscose fibers, and bioplastics; and combinations thereof. The filter may be located at the downstream end of the aerosol-generating article. The filter may be a cellulose acetate filter plug. The filter may have a length of between about 5 mm and about 15 mm, or between about 5 mm and about 10 mm.

Aerosol-generating articles according to the invention may comprise a mouth end cavity at the downstream end of the article. The mouth end cavity may be defined by one or more wrappers extending downstream from the filter or mouthpiece. Alternatively, the mouth end cavity may be defined by a separate tubular element provided at the downstream end of the aerosol-generating article.

Aerosol-generating articles according to the invention preferably further comprise a ventilation zone provided at a location along the aerosol-generating article. For example, the aerosol-generating article may be provided at a location along a hollow tube provided downstream of the aerosol-generating substrate.

Aerosol-generating articles according to the invention may optionally further comprise an upstream element at the upstream end of the aerosol-generating substrate. The upstream element may be a porous plug element, such as a plug of fibrous filtration material such as cellulose acetate. Alternatively, the upstream element may be in the form of a hollow tubular element.

In preferred embodiments of the invention, the aerosol-generating article comprises the aerosol-generating substrate, at least one hollow tube downstream of the aerosol-generating substrate and a filter downstream of the at least one hollow tube. Optionally, the aerosol-generating article further comprises a mouth end cavity at the downstream end of the filter. Preferably, a ventilation zone is provided at a location along the at least one hollow tube.

In a particularly preferred embodiment having this arrangement, the aerosol-generating article comprises an aerosol-generating substrate, an upstream element at the upstream end of the aerosol-generating substrate, a support element downstream of the aerosol-generating substrate, an aerosol-cooling element downstream of the support element and a filter downstream of the aerosol-cooling element. Preferably, the support element and the aerosol-cooling element are both in the form of a hollow tube. Preferably, the aerosol-generating substrate comprises an elongate susceptor element extending longitudinally through it.

In a further preferred embodiment, the aerosol-generating article comprises an aerosol-generating substrate, an upstream element at the upstream end of the aerosol-generating substrate, a single hollow tube downstream of the aerosol-generating substrate and a filter downstream of the hollow tube.

The aerosol-generating articles of the present invention may optionally comprise a combustible heat source and an aerosol-generating substrate downstream of the combustible heat source, the aerosol-generating substrate as described above with respect to the first aspect of the invention.

For example, substrates as described herein may be used in heated aerosol-generating articles of the type disclosed in WO-A-2009/022232, which comprise a combustible carbon-based heat source, an aerosol-generating substrate downstream of the combustible heat source, and a heat-conducting element around and in contact with a rear portion of the combustible carbon-based heat source and an adjacent front portion of the aerosol-generating substrate. However, it will be appreciated that substrates as described herein may also be used in heated aerosol-generating articles comprising combustible heat sources having other constructions.

Alternatively, the aerosol-generating articles according to the present invention as described herein may be adapted for use in electrically-operated aerosol-generating systems in which the aerosol-generating substrate of the heated aerosol-generating article is heated by an electrical heat source.

For example, aerosol-generating substrates as described herein may be used in heated aerosol-generating articles of the type disclosed in EP-A-0 822 760.

The heating element of such aerosol-generating devices may be of any suitable form to conduct heat. The heating of the aerosol-generating substrate may be achieved internally, externally or both. The heating element may preferably be a heater blade or pin adapted to be inserted into the substrate so that the substrate is heated from inside. Preferably, the heating element may partially or completely surround the substrate and externally heat the substrate circumferentially from the outside.

The aerosol-generating system may be an electrically-operated aerosol generating system comprising an inductive heating device. Inductive heating devices typically comprise an induction source that is configured to be coupled to a susceptor, which may be provided externally to the aerosol-generating substrate or internally within the aerosol-generating substrate. The induction source generates an alternating electromagnetic field that induces magnetization or eddy currents in the susceptor. The susceptor may be heated as a result of hysteresis losses or induced eddy currents which heat the susceptor through ohmic or resistive heating.

Electrically operated aerosol-generating systems comprising an inductive heating device may also comprise the aerosol-generating article having the aerosol-generating substrate and a susceptor in thermal proximity to the aerosol-generating substrate. Typically, the susceptor is in direct contact with the aerosol-generating substrate and heat is transferred from the susceptor to the aerosol-generating substrate primarily by conduction. Examples of electrically operated aerosol-generating systems having inductive heating devices and aerosol-generating articles having susceptors are described in WO-A1-95/27411 and WO-A1-2015/177255.

The aerosol-generating substrates of the present invention are preferably adapted to provide an optimised release of aerosol when heated to a temperature of between about 230 degrees Celsius and 270 degrees Celsius. Aerosol-generating articles according to the invention are therefore particularly suitable for use in conjunction with aerosol-generating devices which heat the aerosol-generating substrate externally, or by induction, as described above. With such devices, the aerosol-generating substrate will typically be heated to a temperature that is significantly lower than in aerosol-generating devices comprising internal heating means.

It has been found that when heated to a temperature of between 230 degrees and 270 degrees Celsius in an aerosol-generating device, aerosol-generating substrates of the present invention comprising tobacco particles are capable of providing a nicotine extraction rate that is at least comparable to (and in some cases higher than) that achieved from an aerosol-generating substrate comprising a sheet of homogenised tobacco material which is heated to a temperature of around 350 degrees Celsius in an aerosol-generating device comprising an internal heating element that is inserted into the aerosol-generating substrate during use. This is demonstrated, for example, in the comparative example provided below.

Below, there is provided a non-exhaustive list of non-limiting examples. Any one or more of the features of these examples may be combined with any one or more features of another example, embodiment, or aspect described herein. Any references in these examples to aerosol-generating substrates according to the invention should also be considered as referring to the aerosol-generating substrate of aerosol-generating articles according to the invention.

EX1. An aerosol-generating substrate for an aerosol-generating article, the aerosol-generating substrate comprising: a porous medium loaded with an aerosol-generating suspension of plant particles in a liquid solvent comprising one or more aerosol formers.
EX2. An aerosol-generating substrate according to example EX1, wherein the aerosol-generating suspension comprises at least 20 percent by weight of the plant particles.
EX3. An aerosol-generating substrate according to examples EX1 or EX2, wherein the aerosol-generating suspension comprises at least 30 percent by weight of the one or more aerosol formers.
EX4. An aerosol-generating substrate according to any of the preceding examples, wherein the aerosol-generating suspension comprises up to 50 percent by weight of the plant particles.
EX5. An aerosol-generating substrate according to any of the preceding examples, wherein the aerosol-generating substrate comprises at least 8 percent by weight of the plant particles.
EX6. An aerosol-generating substrate according to any of the preceding examples, wherein the aerosol-generating substrate comprises up to 40 percent by weight of the plant particles.
EX7. An aerosol-generating substrate according to any of the preceding examples, wherein the aerosol-generating substrate comprises plant particles produced from ground or powdered leaf lamina, fruits, stalks, stems, roots, seeds, buds or bark.
EX8. An aerosol-generating substrate according to any of the preceding examples, wherein the aerosol-generating suspension comprises tobacco particles.
EX9. An aerosol-generating substrate according to any of examples EX1 to EX7, wherein the aerosol-generating suspension is free from tobacco particles.
EX10. An aerosol-generating substrate according to any of the preceding examples, wherein the aerosol-generating suspension comprises non-tobacco particles selected from mint leaf particles, rosemary particles, ginger particles, star anise particles, clove particles, eucalyptus particles, oregano particles, thyme particles, dill seed particles, chamomile particles, cumin seed particles, tea particles, cannabis particles, or combinations thereof.
EX11. An aerosol-generating substrate according to any of the preceding examples, wherein the aerosol-generating suspension comprises a combination of non-tobacco and tobacco particles and wherein the ratio of non-tobacco particles to tobacco particles is between 1:5 and 5:1.
EX12. An aerosol-generating substrate according to any of the preceding examples, wherein the plant particles have an average particle size of between 20 microns and 200 microns.
EX13. An aerosol-generating substrate according to any of the preceding examples, wherein the aerosol-generating suspension further comprises an inert thickening agent.
EX14. An aerosol-generating substrate according to any of the preceding examples, wherein the liquid solvent of the aerosol-generating suspension comprises glycerol.
EX15. An aerosol-generating substrate according to any of the preceding examples, wherein the aerosol-generating suspension comprises at least 35 percent by weight of the one or more aerosol formers.
EX16. An aerosol-generating substrate according to any of the preceding examples, wherein the aerosol-generating suspension comprises up to 90 percent by weight of the one or more aerosol formers.
EX17. An aerosol-generating substrate according to any of the preceding examples, wherein the aerosol-generating substrate comprises at least 25 percent by weight of the one or more aerosol formers.
EX18. An aerosol-generating substrate according to any of the preceding examples, wherein the aerosol-generating substrate comprises up to 75 percent by weight of the one or more aerosol formers.
EX19. An aerosol-generating substrate according to any of the preceding examples, wherein the aerosol-generating substrate comprises at least 25 percent by weight of the one or more aerosol formers.
EX20. An aerosol-generating substrate according to any of the preceding examples, wherein the liquid solvent of the aerosol-generating suspension comprises water.
EX21. An aerosol-generating substrate according to example EX20, wherein the liquid solvent of the aerosol-generating suspension comprises at least 5 percent by weight of water.
EX22. An aerosol-generating substrate according to example EX20 or EX21, wherein the liquid solvent of the aerosol-generating suspension comprises up to 30 percent by weight of water.
EX23. An aerosol-generating substrate according to any of examples EX20 to EX22, wherein the aerosol-generating substrate comprises up to 25 percent by weight of water.
EX24. An aerosol-generating substrate according to any of the preceding examples, wherein the liquid solvent of the aerosol-generating suspension further comprises an alkaline agent.
EX25. An aerosol-generating substrate according to example EX24, wherein the alkaline agent is sodium hydroxide, potassium hydroxide, magnesium hydroxide or calcium hydroxide.
EX26. An aerosol-generating substrate according to example EX24, wherein the alkaline agent is sodium hydroxide.
EX27. An aerosol-generating substrate according to any of examples EX24 to EX 26, wherein the pH of the aerosol-generating suspension is at least 6.
EX28. An aerosol-generating substrate according to any of examples EX24 to EX 27, wherein the pH of the aerosol-generating suspension is up to 9.
EX29. An aerosol-generating substrate according to any of examples EX24 to EX28, wherein the aerosol-generating suspension comprises at least 0.1 percent by weight of the alkaline agent.
EX30. An aerosol-generating substrate according to any of examples EX24 to EX29, wherein the aerosol-generating suspension comprises up to 5 percent by weight of the alkaline agent.
EX31. An aerosol-generating substrate according to any of examples EX24 to EX29, wherein the aerosol-generating substrate comprises up to 4 percent by weight of the alkaline agent.
EX32. An aerosol-generating substrate according to any of the preceding examples, wherein the liquid solvent of the aerosol-generating suspension further comprises nicotine.
EX33. An aerosol-generating substrate according to example EX32, wherein the aerosol-generating suspension comprises liquid nicotine.
EX34. An aerosol-generating substrate according to any of the preceding examples, wherein the liquid solvent of the aerosol-generating suspension further comprises one or more acids.
EX35. An aerosol-generating substrate according to example EX34, wherein the aerosol-generating suspension comprises benzoic acid, lactic acid, fumaric acid, levulinic acid, acetic acid or a combination thereof.
EX36. An aerosol-generating substrate according to any of the preceding examples, wherein the weight ratio of the liquid solvent to the plant particles in the aerosol-generating suspension is at least 1.
EX37. An aerosol-generating substrate according to any of the preceding examples, wherein the weight ratio of the liquid solvent to the plant particles in the aerosol-generating suspension is up to 4.
EX38. An aerosol-generating substrate according to any of the preceding examples, wherein the weight ratio of the liquid solvent to the total solids in the aerosol-generating suspension is at least 1.
EX39. An aerosol-generating substrate according to any of the preceding examples, wherein the weight ratio of the liquid solvent to the total solids in the aerosol-generating suspension is up to 4.
EX40. An aerosol-generating substrate according to any of the preceding examples, wherein the porous medium is formed of a fibrous material.
EX41. An aerosol-generating substrate according to example EX40, wherein the fibrous material is in the form of a cellulosic sheet.
EX42. An aerosol-generating substrate according to example EX40 or EX41, wherein the porous medium comprises one or more crimped sheets.
EX43. An aerosol-generating substrate according to any of the preceding examples, wherein the porous medium accounts for between 10 percent and 30 percent by weight of the aerosol-generating substrate.
EX44. An aerosol-generating substrate according to any of the preceding examples, wherein the weight ratio of the aerosol-generating suspension to the porous medium within the aerosol-generating substrate is at least 3.
EX45. An aerosol-generating substrate according to any of the preceding examples, wherein the weight ratio of the aerosol-generating suspension to the porous medium within the aerosol-generating substrate is up to 8.
EX46. An aerosol-generating substrate according to any of the preceding examples, further comprising one or more susceptor elements.
EX47. An aerosol-generating substrate according to any of the preceding examples, wherein the aerosol-generating substrate has a length of between 5 millimetres and 12 millimetres.
EX48. A method of producing an aerosol-generating substrate according to any of the preceding examples, the method comprising the steps of:
providing a liquid solvent comprising one or more aerosol formers and optionally water;
providing a plant powder formed of plant particles;
mixing the plant powder with the liquid solvent to form a suspension of the plant particles in the liquid solvent; and
depositing the suspension onto a porous medium to form the aerosol-generating substrate.
   EX49. An aerosol-generating article comprising a rod of the aerosol-generating substrate according to any of the examples EX1 to E48, circumscribed by an outer wrapper.
   EX50. An aerosol-generating article according to example EX49 further comprising a support element comprising at least one hollow tube downstream of the aerosol-generating substrate.
   EX51. An aerosol-generating article according to example EX49 or EX50, further comprising an aerosol-cooling element downstream of the aerosol-generating substrate.
   EX52. An aerosol-generating article according to any of examples EX49 to EX51, further comprising a mouthpiece downstream of the aerosol-generating substrate.
   EX53. An aerosol-generating article according to any of examples EX49 to EX51, further comprising an upstream element at the upstream end of the aerosol-generating substrate.
   EX54. An aerosol-generating article according to any of examples EX49 to EX53 comprising an upstream element at the upstream end of the aerosol-generating substrate, a support element downstream of the aerosol-generating substrate, an aerosol-cooling element downstream of the support element and a filter downstream of the aerosol-cooling element.

A specific embodiment will be further described, by way of example only, with reference to the accompanying drawing in which:

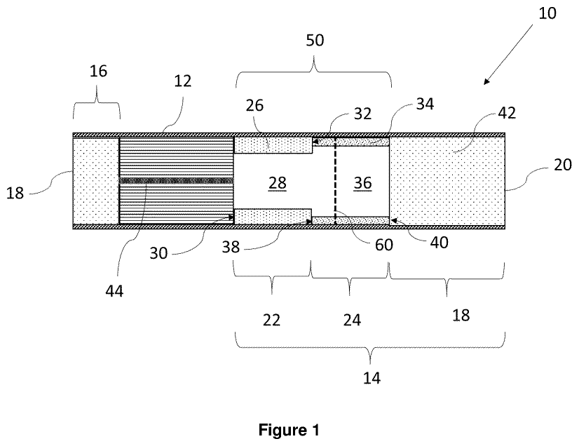

FIG. 1 provides a schematic side sectional view (not to scale) of an aerosol-generating article according to a first embodiment of the invention, which is suitable for induction heating.

The aerosol-generating article 10 shown in FIG. 1 comprises a rod 12 of aerosol-generating substrate 12 and a downstream section 14 at a location downstream of the rod 12 of aerosol-generating substrate. Further, the aerosol-generating article 10 comprises an upstream section 16 at a location upstream of the rod 12 of aerosol-generating substrate. Thus, the aerosol-generating article 10 extends from an upstream or distal end 18 to a downstream or mouth end 20.

The aerosol-generating article 10 has an overall length of about 45 millimetres.

The downstream section 14 comprises a support element 22 located immediately downstream of the rod 12 of aerosol-generating substrate, the support element 22 being in longitudinal alignment with the rod 12. In the embodiment of FIG. 1, the upstream end of the support element 22 abuts the downstream end of the rod 12 of aerosol-generating substrate. In addition, the downstream section 14 comprises an aerosol-cooling element 24 located immediately downstream of the support element 22, the aerosol-cooling element 24 being in longitudinal alignment with the rod 12 and the support element 22. In the embodiment of FIG. 1, the upstream end of the aerosol-cooling element 24 abuts the downstream end of the support element 22.

The support element 22 comprises a first hollow tubular segment 26. The first hollow tubular segment 26 is provided in the form of a hollow cylindrical tube made of cellulose acetate. The first hollow tubular segment 26 defines an internal cavity 28 that extends all the way from an upstream end 30 of the first hollow tubular segment to an downstream end 32 of the first hollow tubular segment 20. The internal cavity 28 is substantially empty, and so substantially unrestricted airflow is enabled along the internal cavity 28. The first hollow tubular segment 26—and, as a consequence, the support element 22—does not substantially contribute to the overall RTD of the aerosol-generating article 10. In more detail, the RTD of the first hollow tubular segment 26 (which is essentially the RTD of the support element 22) is substantially 0 millimetres H₂O.

The first hollow tubular segment 26 has a length of about 7 millimetres and an external diameter of about 7.25 millimetres.

The aerosol-cooling element 24 comprises a second hollow tubular segment 34. The second hollow tubular segment 34 is provided in the form of a hollow cylindrical tube made of cardboard. The second hollow tubular segment 34 defines an internal cavity 36 that extends all the way from an upstream end 38 of the second hollow tubular segment to a downstream end 40 of the second hollow tubular segment 34. The internal cavity 36 is substantially empty, and so substantially unrestricted airflow is enabled along the internal cavity 36. The second hollow tubular segment 34—and, as a consequence, the aerosol-cooling element 24—does not substantially contribute to the overall RTD of the aerosol-generating article 10. In more detail, the RTD of the second hollow tubular segment 34 (which is essentially the RTD of the aerosol-cooling element 24) is substantially 0 millimetres H₂O.

The second hollow tubular segment 34 has a length of about 17 millimetres and an external diameter of about 7.25 millimetres.

The aerosol-generating article 10 comprises a ventilation zone (not shown) provided at a location along the second hollow tubular segment 34.

In the embodiment of FIG. 1, the downstream section 14 further comprises a mouthpiece element 42 at a downstream end of the aerosol-generating article 10. In more detail, the mouthpiece element 42 is positioned immediately downstream of the aerosol-cooling element 24. As shown in the drawing of FIG. 1, an upstream end of the mouthpiece element 42 abuts the downstream end 40 of the aerosol-cooling element 24.

The mouthpiece element 42 is provided in the form of a cylindrical plug of low-density cellulose acetate.

The mouthpiece element 42 has a length of about 5 millimetres and an external diameter of about 7.25 millimetres.

The rod 12 comprises an aerosol-generating substrate according to the present invention comprising an aerosol-generating suspension loaded onto a porous medium. The porous medium is in the form of a crimped cotton sheet. The cotton sheet, with the aerosol-generating suspension loaded onto it, has been gathered, crimped and wrapped in a filter paper to form the rod 12. A number of examples of suitable aerosol-generating suspension for forming the aerosol-generating substrate are shown in Table 1 below.

The rod 12 of aerosol-generating substrate has an external diameter of about 7.25 millimetres and a length of about 7 millimetres.

The aerosol-generating article 10 further comprises an elongate susceptor element 44 within the rod 12 of aerosol-generating substrate. In more detail, the susceptor element 44 is arranged substantially longitudinally within the aerosol-generating substrate, such as to be approximately parallel to the longitudinal direction of the rod 12. As shown in the drawing of FIG. 1, the susceptor element 44 is positioned in a radially central position within the rod and extends effectively along the longitudinal axis of the rod 12.

The susceptor element 44 extends all the way from an upstream end to a downstream end of the rod 12. In effect, the susceptor element 44 has substantially the same length as the rod 12 of aerosol-generating substrate.

In the embodiment of FIG. 1, the susceptor element 44 is provided in the form of a strip and has a length of about 12 millimetres, a thickness of about 60 micrometres, and a width of about 4 millimetres. The upstream section 16 comprises an upstream element 46 located immediately upstream of the rod 12 of aerosol-generating substrate, the upstream element 46 being in longitudinal alignment with the rod 12. In the embodiment of FIG. 1, the downstream end of the upstream element 46 abuts the upstream end of the rod 12 of aerosol-generating substrate. This advantageously prevents the susceptor element 44 from being dislodged. Further, this ensures that the consumer cannot accidentally contact the heated susceptor element 44 after use.

The upstream element 46 is provided in the form of a cylindrical plug of cellulose acetate circumscribed by a stiff wrapper. The upstream element 46 has a length of about 5 millimetres.

In alternative embodiments, the aerosol-generating article may be produced without the elongate susceptor element in the rod 12 of aerosol-generating substrate. Such embodiments are suitable for use with an aerosol-generating device comprising an internal or external heating device for heating the aerosol-generating substrate during use, as described above.

### EXAMPLE

Different samples of aerosol-generating suspension for use in an aerosol-generating substrate according to the present invention, as described above with reference to the figures, may be prepared with the compositions shown in Table 1.

For each of the compositions, a liquid solvent was first prepared by combining the aerosol former with the water and alkaline agent (where present) and mixing to form a homogeneous solution. The tobacco powder and botanical powder (where present) were ground to an average particle size of 55 microns and then added to the liquid solvent to form a heterogeneous suspension. The resultant suspension was deposited onto a porous medium in the form of crimped cotton sheet and the crimped cotton sheet was gathered and crimped to form a rod, which was circumscribed by a wrapper.

TABLE 1
Composition of aerosol-generating suspensions

| | Tobacco | Botanical | Glycerol | | |
|---|---|---|---|---|---|
| Sample | powder (%) | powder (%) | (%) | Water (%) | NaOH (%) |
| A | 20 | 10 | 60 | 10 | 0 |
| B | 30 | 0 | 59.5 | 10 | 0.5 |
| C | 32 | 0 | 58 | 9 | 1 |
| D | 33 | 0 | 66 | 0 | 1 |
| E | 40 | 0 | 60 | 0 | 0 |
| F | 30 | 0 | 50 | 20 | 0 |
| G | 30 | 0 | 70 | 0 | 0 |

### Comparative Example 1

For each of the samples B and C from Table 1 above, a rod was formed as described above but additionally incorporating an elongate susceptor element within the rod. The resultant rod was heated in an induction heating device to a temperature of 267 degrees Celsius under a Health Canada machine-smoking regime (as described in ISO/TR 19478-1:2014), in order to generate a nicotine containing aerosol. The aerosol was collected and the total amount of nicotine in the aerosol was measured. The nicotine extraction rate was then calculated, by dividing the amount of nicotine in the aerosol by the amount of nicotine in the substrate prior to heating. A similar test was conducted on a rod formed from a conventional cast leaf tobacco substrate. The results of the test are shown in Table 2 below.

As shown in Table 2, the samples B and C including an aerosol-generating substrate according to the invention with an aerosol-generating suspension comprising tobacco particles provided a significantly higher nicotine extraction rate when inductively heated at a temperature of 267 degrees Celsius than the nicotine extraction rate provided upon heating of a conventional cast leaf substrate under the same heating conditions. By way of a further comparison, the nicotine extraction rate measured for an aerosol-generating article comprising a cast leaf substrate but which is heated at a higher temperature of 350 degrees Celsius, for example, by an internal heater, is around 0.24. The aerosol-generating substrates according to the invention, in samples B and D, are therefore able to provide a similar nicotine extraction rate to existing aerosol-generating articles but at a significantly lower temperature, so that the formation of certain undesirable compounds from the tobacco can be reduced.

TABLE 2
Nicotine extraction rate

| | Amount of nicotine | Amount of nicotine | Nicotine |
|---|---|---|---|
| Substrate | in substrate (mg) | in aerosol (mg) | extraction rate |
| Sample B | 1.5 | 0.43 | 0.29 |
| Sample C | 2.9 | 0.7 | 0.24 |
| Cast leaf | 5.35 | 0.6 | 0.11 |

### Comparative Example 2—Effect of Alkaline Agent

For each of the samples D and E from Table 1 above, a rod was formed as described above but additionally incorporating an elongate susceptor element within the rod. Samples D and E both include tobacco particles and glycerol but sample D additionally includes an alkaline agent in the form of NaOH. Each of the resultant rods was heated in an induction heating device to a temperature of 235 degrees Celsius under a Health Canada heating regime, in order to generate a nicotine containing aerosol. For each puff of aerosol, the amount of nicotine in the aerosol was measured. The results of the test are shown in Table 3 below.

As demonstrated by the results below, the inclusion of the alkaline agent in sample D produces a significant increase in the delivery of nicotine in the aerosol compared to sample E without any alkaline agent. Overall, the delivery of nicotine from sample D is almost double the delivery of nicotine from sample E, despite the fact that sample E contains a higher amount of tobacco particles.

TABLE 3
Effect of alkaline agent on nicotine extraction

| | Amount of nicotine in | Amount of nicotine in | |
|---|---|---|---|
| Puff | aerosol (μg) - Sample D | aerosol (μg) - Sample E | % increase |
| 1 | 28 | 8 | 250 |
| 2 | 18 | 8 | 125 |
| 3 | 22 | 10 | 120 |
| 4 | 26 | 13 | 100 |
| 5 | 28 | 14 | 100 |
| 6 | 30 | 16 | 87.5 |
| 7 | 32 | 17 | 88.2 |
| 8 | 34 | 18 | 88.9 |
| 9 | 35 | 19 | 84.2 |
| 10 | 35 | 19 | 84.2 |
| 11 | 36 | 19 | 89.5 |
| 12 | 35 | 19 | 84.2 |
| Total | 359 | 180 | 99.4 |

### Comparative Example 3—Effect of Water

For each of the samples F and G from Table 1 above, a rod was formed as described above but additionally incorporating an elongate susceptor element within the rod. Samples F and G both include tobacco particles and glycerol but sample F additionally includes water. Each of the resultant rods was heated in an induction heating device to a temperature of 267 degrees Celsius under a Health Canada heating regime, in order to generate a nicotine containing aerosol. For each puff of aerosol, the amount of nicotine in the aerosol was measured. The results of the test are shown in Table 4 below.

As demonstrated by the results below, the inclusion of the water in sample F produces a significant increase in the delivery of nicotine in the aerosol compared to sample G without any water. Overall, the delivery of nicotine from sample F is over 50 percent higher than the delivery of nicotine from sample G.

TABLE 4
Effect of water on nicotine extraction

| | Amount of nicotine in | Amount of nicotine in | |
|---|---|---|---|
| Puff | aerosol (μg) - Sample F | aerosol (μg) - Sample G | % increase |
| 1 | 10 | 9 | 11.1 |
| 2 | 12 | 9 | 33.3 |
| 3 | 23 | 14 | 64.3 |
| 4 | 34 | 19 | 78.9 |
| 5 | 41 | 23 | 78.3 |
| 6 | 46 | 26 | 73.1 |
| 7 | 45 | 28 | 64.3 |
| 8 | 46 | 28 | 60.7 |
| 9 | 42 | 29 | 44.8 |
| 10 | 40 | 28 | 42.9 |
| 11 | 37 | 28 | 32.1 |
| 12 | 34 | 27 | 25.9 |
| Total | 409 | 268 | 52.6 |

1.-15. (canceled)

16. An aerosol-generating article comprising an aerosol-generating substrate, the aerosol-generating substrate comprising a porous medium loaded with an aerosol-generating suspension of plant particles in a liquid solvent comprising one or more aerosol formers, the aerosol-generating suspension comprising at least 20 percent by weight of the plant particles and at least 30 percent by weight of the one or more aerosol formers.

17. The aerosol-generating article according to claim 16, wherein the plant particles have an average particle size of between 20 microns and 200 microns.

18. The aerosol-generating article according to claim 16, wherein a weight ratio of the liquid solvent to the plant particles is at least 1.5.

19. The aerosol-generating article according to claim 16, wherein the porous medium is formed of a fibrous sheet formed of a cellulosic material.

20. The aerosol-generating article according to claim 19, wherein the porous medium comprises a crimped cotton sheet.

21. The aerosol-generating article according to claim 16, wherein the liquid solvent of the aerosol-generating suspension further comprises at least 5 percent by weight of water.

22. The aerosol-generating article according to claim 16, wherein the plant particles in the aerosol-generating suspension comprise tobacco particles.

23. The aerosol-generating article according to claim 22, wherein the liquid solvent of the aerosol-generating suspension further comprises an alkaline agent.

24. The aerosol-generating article according to claim 16, wherein the plant particles in the aerosol-generating suspension comprise non-tobacco plant particles.

25. The aerosol-generating article according to claim 24, wherein the aerosol-generating suspension is substantially free from tobacco particles.

26. The aerosol-generating article according to claim 24, wherein the aerosol-generating suspension further comprises nicotine.

27. The aerosol-generating article according to claim 16, wherein a weight ratio of the aerosol-generating suspension to the porous medium is at least 3.

28. The aerosol-generating article according to claim 16, further comprising a susceptor element.

29. The aerosol-generating article according to claim 16, further comprising a rod formed of the aerosol-generating substrate, circumscribed by an outer wrapper.

30. A method of producing an aerosol-generating substrate for the aerosol-generating article according to claim 16, the method comprising the steps of:
providing a liquid solvent comprising one or more aerosol formers;
providing a plant powder formed of plant particles;
mixing the plant powder with the liquid solvent to form an aerosol-generating suspension of the plant particles in the liquid solvent; and
depositing the aerosol-generating suspension onto a porous medium to form the aerosol-generating substrate.

31. The method according to claim 30, wherein the liquid solvent further comprises water.
